(19) United States
(12) Patent Application Publication
(10) Pub. No.: US 2009/0172410 A1
(43) Pub. Date: Jul. 2, 2009

(54) PERSONAL VAULT

(75) Inventor: Moshe Maor, Santa Clara, CA (US)

Correspondence Address: INTEL CORPORATION;c/o CPA Global, P.O. BOX 52050, MINNEAPOLIS, MN, 55402, US

(73) Assignee: INTEL CORPORATION, Santa Clara, CA (US)

(21) Appl. No.: 11/967,999

(22) Filed: Dec. 31, 2007

(51) Int. Cl. G06F 21/24

(52) U.S. Cl. 713/189

(57) ABSTRACT

In some embodiments data input to an input device is encrypted before it is received by any software, and information is stored securely so that the information is not accessible to any software. Other embodiments are described and claimed.

### RELATED APPLICATIONS

This application is related to the following applications filed on the same date as this application:
“Personal Guard” by Moshe Maor, Attorney Docket Number P25461;
“Management Engine Secured Input” to Moshe Maor, Attorney Docket Number P25460;
“Secure Input” to Douglas Gabel and Moshe Maor, Attorney Docket Number P26882;
“Secure Client/Server Transactions” to Moshe Maor, Attorney Docket Number P26890.

### TECHNICAL FIELD

The inventions generally relate to a personal vault.

### BACKGROUND

Many different types of keyloggers currently exist to allow hackers to hook into different layers in the software stack of a user's computer. The hooking point can be as low (that is, as close to the hardware) as a keyboard base driver or as high (that is, as far from the hardware) as a script that runs inside the scope of an internet browser. In this manner, software based keyloggers and other types of malware may be used by a hacker to hijack sensitive information that a user types into a computer. Therefore, a need has arisen to protect a user's sensitive information from a hacker using keyloggers and other types of malware.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates a system according to some embodiments of the inventions.

FIG. 2 illustrates a system according to some embodiments of the inventions.

FIG. 3 illustrates a system according to some embodiments of the inventions.

FIG. 4 illustrates a sequence diagram according to some embodiments of the inventions.

FIG. 5 illustrates a graphic representation according to some embodiments of the inventions.

FIG. 6 illustrates a sequence diagram according to some embodiments of the inventions.

FIG. 7 illustrates a sequence diagram according to some embodiments of the inventions.

### DETAILED DESCRIPTION

Some embodiments of the inventions relate to a personal vault.

In some embodiments data input to an input device is encrypted before it is received by any software.

In some embodiments a controller is to encrypt data input to an input device before it is received by any software.

In some embodiments a secure path is provided between an input device and a controller and a secure path is provided between the controller and a remote server.

In some embodiments a controller is to provide a secure path between an input device and the controller. The controller is also to provide a secure path between the controller and a remote server.

In some embodiments a system includes a computer and a remote server. The computer includes an input device and a controller. The controller is to provide a secure path between the input device and the controller. The controller and the server interact to provide a secure path between the controller and the server.

In some embodiments an article (such as a tangible physical article) includes a computer readable medium having instructions thereon which when executed cause a computer to encrypt data input to an input device before it is received by any software.

In some embodiments data input to an input device is encrypted before it is received by any software, and information is stored securely so that the information is not accessible to any software.

In some embodiments a controller is to encrypt data input to an input device before it is received by any software. The controller is to control a secure storage in a manner that information stored in the secure storage is not accessible to any software.

In some embodiments an article (such as a tangible physical article) includes a computer readable medium having instructions thereon which when executed cause a computer to encrypt data input to an input device before it is received by any software, and to store securely information so that the information is not accessible to any software.

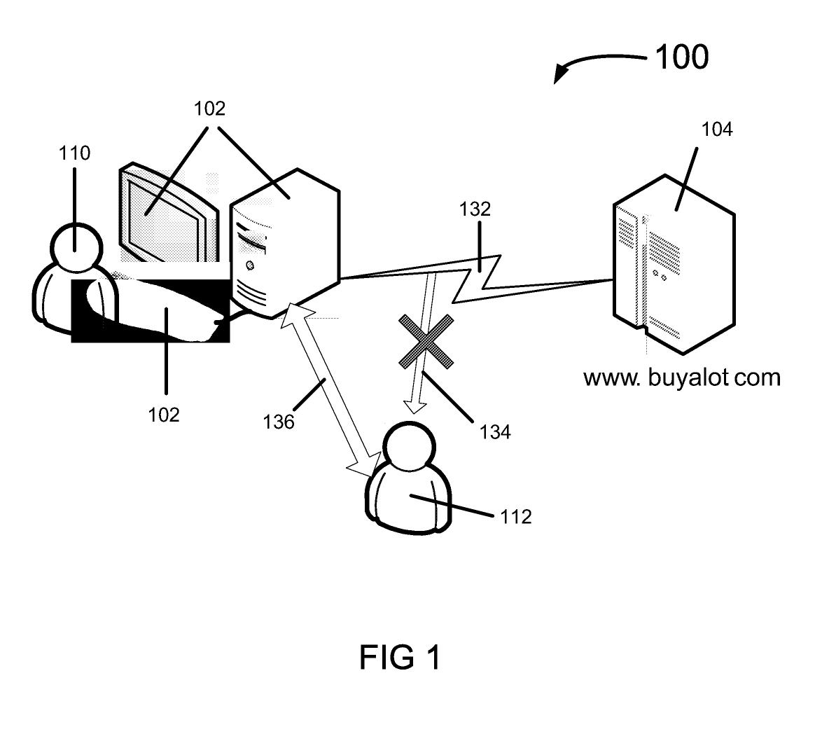

FIG. 1 illustrates a system 100 according to some embodiments. In some embodiments system 100 includes a computer 102 and a remote server 104. FIG. 1 illustrates how an end user 110 (for example, an on-line purchaser of goods and/or services) that is doing some on-line shopping using the computer 102 that is connected to the remote server 104 (for example, via the internet) may be open to attacks from a hacker 112. In the on-line shopping example, a common scenario might include the following numbered steps:

1. The end user 110 is using an internet browser loaded on computer 102 to surf in an e-commerce web site to choose good for purchase (for example, via a remote server 104 of a “www.buyalot.com” web site)
2. The user 110 picks some goods from the “www.buyalot.com” web site and places them into a virtual basket
3. At some point when the user 110 has finished choosing goods for purchase, the user hits a checkout button
4. The e-commerce server 104 opens a form in a window for the user 110 and asks for the user to enter payment information in the form
5. The user 110 types sensitive data into fields of the form such as, for example, a credit card number, phone number, full name, address, etc.
6. The e-commerce server 104 sends back a receipt to the user

During the most sensitive portions of the exemplary scenario discussed above (for example, during steps 4 and 5), the communication between the internet browser of the user 110 and the server 104 of the remote site is typically run on top of a secured connection 132 such as a secure socket layer (SSL) and/or a transfer layer security (TLS), for example. This precludes any adversary such as hacker 112 on the internet that wishes to capture the sensitive data entered by the user from obtaining that data without first breaking cryptographic algorithms used by the secured connected (that is, SSL and/or TLS cryptographic algorithms). This is not typically a problem due to a very high computation complexity that would be required by the hacker 112. Arrow 134 illustrates an attempt by hacker 112 to obtain information via this method. An “X” is included over arrow 134 to illustrate the extreme difficulties in attempting this type of theft attempt.

The typical user 110 is normally aware of the fact that some protection is necessary in order to avoid theft of personal information entered in such a scenario. For example, most users know to look for a special icon normally displayed on a control line of the internet browser that indicates that the current session is being executed over a secured connection. However, a sophisticated hacker 112 may attempt to steal the sensitive information using a completely different approach that is not protected by using a secured connection 132 such as SSL or TLS. For example, hacker 112 may use a keylogger to obtain the sensitive information, as illustrated via arrow 136 in FIG. 1. Many different types of keyloggers are currently available, and have the ability to hook into different layers in the software stack running on computer 102, for example. The hooking point for the keyloggers can be as low (that is, closer to the hardware) as a keyboard base driver or as high (that is, further from the hardware) as a script that runs inside the scope of the internet browser running on computer 102, for example. Therefore, while it is very important to mitigate network theft attacks on the sensitive data, it is not enough to entirely mitigate theft attacks of sensitive data (resulting, for example, in identity theft).

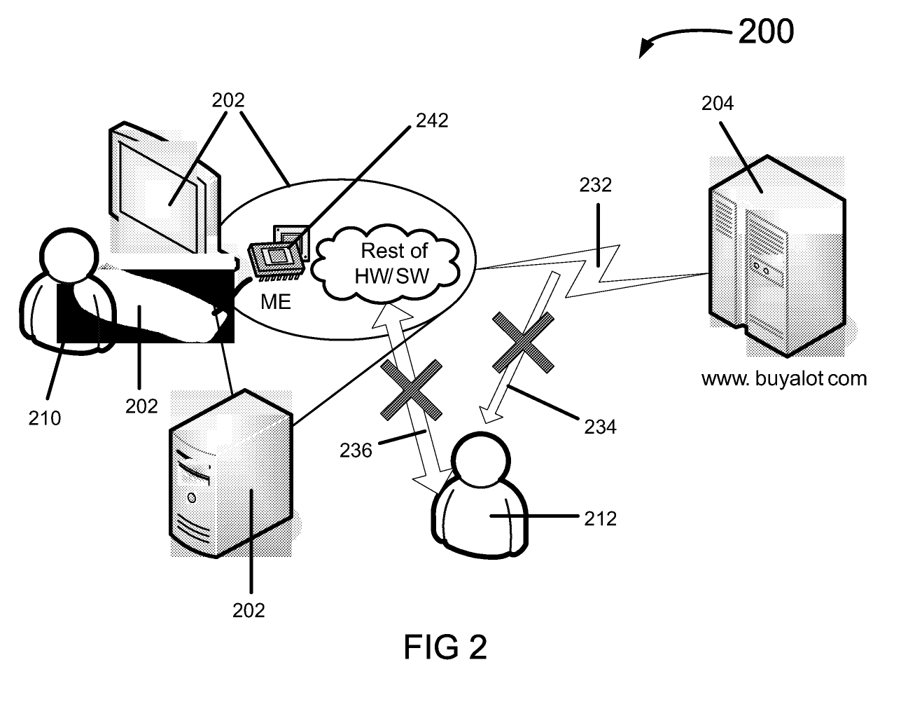

FIG. 2 illustrates a system 200 according to some embodiments. In some embodiments system 200 includes a computer 202 and a remote server 204. FIG. 2 illustrates how an end user 210 (for example, an on-line purchaser of goods and/or services) that is doing some on-line shopping using the computer 202 that is connected to the remote server 204 (for example, via the internet) may guard from attacks from a hacker 212. Similar to the arrangement described in reference to FIG. 1, the communication between the internet browser of the user's computer 202 and the server 204 of the remote site is typically run on top of a secured connection 232 such as a secure socket layer (SSL) and/or a transfer layer security (TLS), for example. This precludes any adversary such as hacker 212 on the internet that wishes to capture the sensitive data entered by the user from obtaining that data without first breaking cryptographic algorithms used by the secured connected (that is, SSL and/or TLS cryptographic algorithms).

Computer 202 includes a management engine (and/or manageability engine and/or ME). In some embodiments, ME 242 is a micro-controller. In some embodiments, ME 242 is included in a chipset of computer 202. In some embodiments, ME 242 is included in a Memory Controller Hub (MCH) of computer 202. In some embodiments, ME 242 is included in a Graphics and Memory Controller Hub of computer 202.

In some embodiments, ME 242 may be implemented using Intel® Active Management Technology (Intel® AMT) and/or may be implemented using a portion of Intel AMT and/or may be implemented using an Intel ME, for example, all available from Intel Corporation and/or within chipsets sold by Intel Corporation. Intel AMT is a silicon-resident management mechanism for remote discovery, healing, and protection of computer systems. It provides the basis for software solutions to address key manageability issues, improving the efficiency of remote management and asset inventory functionality in third-party management software, safeguarding functionality of critical agents from operating system (OS) failure, power loss, and intentional or inadvertent client removal, for example. Intel AMT infrastructure supports the creation of setup and configuration interfaces for management applications, as well as network, security, and storage administration. The platform provides encryption support by means of Transport Layer Security (TLS), as well as robust authentication support.

Intel AMT's core hardware architecture is resident in firmware. A micro-controller within Intel chipset graphics and memory controller hubs houses Management Engine (ME) firmware, which implements various services on behalf of management applications. Locally, the ME can monitor activity such as the heartbeat of a local management agent and automatically take remediation action. Remotely, the external systems can communicate with the ME hardware to perform diagnosis and recovery actions such as installing, loading or restarting agents, diagnostic programs, drivers, and even operating systems.

Personal guard technology included in system 200 can be used to completely mitigate any attempted attacks from keyloggers and other types of malware. In some embodiments, management engine (and/or manageability engine and/or ME) 242 included within computer 202 takes control over the keyboard of the computer 202 and sets up a trusted path between the user 210 and the ME 242 via any input devices of computer 202 such as the keyboard. Additionally, the ME 242 sets up a secured path (although not a direct connection) between the ME 242 and the remote server 204.

When funneling the sensitive data via the ME 242, the ME 242 actually encrypts the sensitive data that the user 210 types, for example, before the software running on computer 202 obtains the data (for example, sensitive data such as credit card numbers, phone numbers, full name, addresses, etc.) In this manner, when the software that runs on the host processor, for example, of computer 202 is handling the data it is already encrypted and is therefore not usable for keyloggers in an attempt to steal the data via arrow 236 by the hacker 212. Therefore, no matter what type of keylooger is able to infiltrate computer 202 and is currently running on the host processor of computer 202 as part of the software stack, the sensitive data of the user 210 is kept secret when personal guard operations (for example, via ME 242) are being used while user 210 is typing the data.

FIG. 2 has described using personal guard operations to mitigate hacker attempts such as keyloggers from stealing sensitive data entered by a user. However, it is recognized that a management engine such as ME 242 of FIG. 2 is not necessary for all embodiments, and that other devices may be used to implement the same types of operations as described herein. Additionally, an Intel branded ME and/or Intel AMT is not necessary for all embodiments, and other devices may be used to implement the same types of operations as described herein.

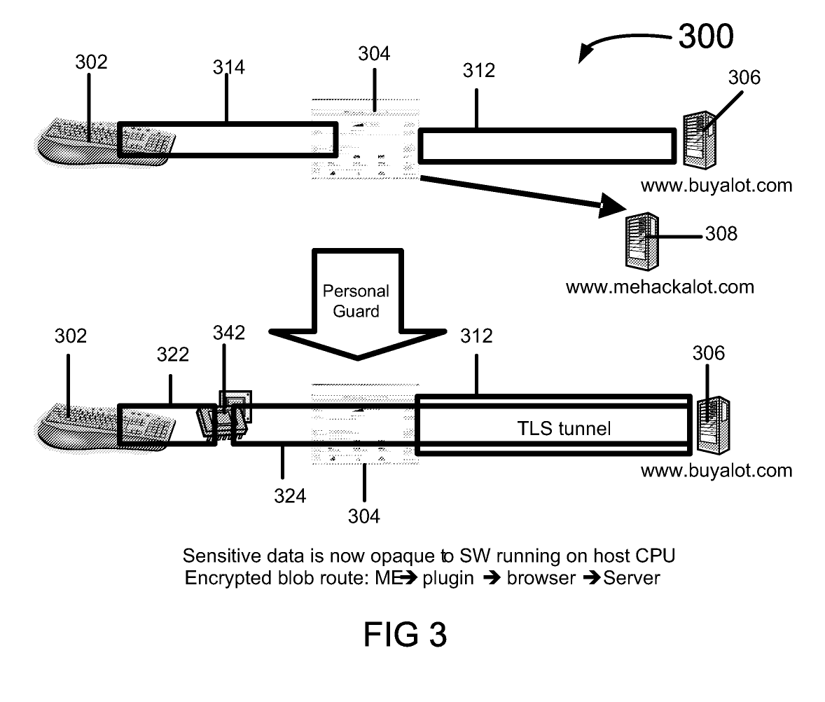

FIG. 3 illustrates a system 300 according to some embodiments. In some embodiments system 300 includes an input device 302 (for example, a keyboard, a mouse, and/or any other type of input device), an Operating System (OS) and/or internet browser 304, a remote server 306, and a hacker (and/or a hacker computer) 308. FIG. 3 illustrates a difference between a system that is guarded by internet based encryption such as SSL or TLS in the top portion of FIG. 3 and a system that is guarded with personal guard technology in a bottom portion of FIG. 3. In the top portion of FIG. 3 a secured connection 312 (for example, using SSL and/or TLS and/or tunneling technology) occurs between the OS/internet browser 304 and the remote server 306, and software based input/output 314 occurs between input device 302 and the OS/internet browser 304. In the scenario illustrated at the top of FIG. 3, the hacker 308 can use malware and/or keyloggers to intercept and make use of sensitive data input by a user. In the bottom of FIG. 3, on the other hand, a secured connection 322 is provided between a portion 342 of a user computer (for example, such as a Management Engine or ME) and the OS/internet browser 304 using personal guard technology according to some embodiments, for example. Additionally, sensitive data is encrypted at 324 between the portion 342 (such as an ME) and the remote server 306 using personal guard technology according to some embodiments, for example. In this manner, software based keyloggers and other types of malware may not be used to hijack sensitive information input by a user at input device 302.

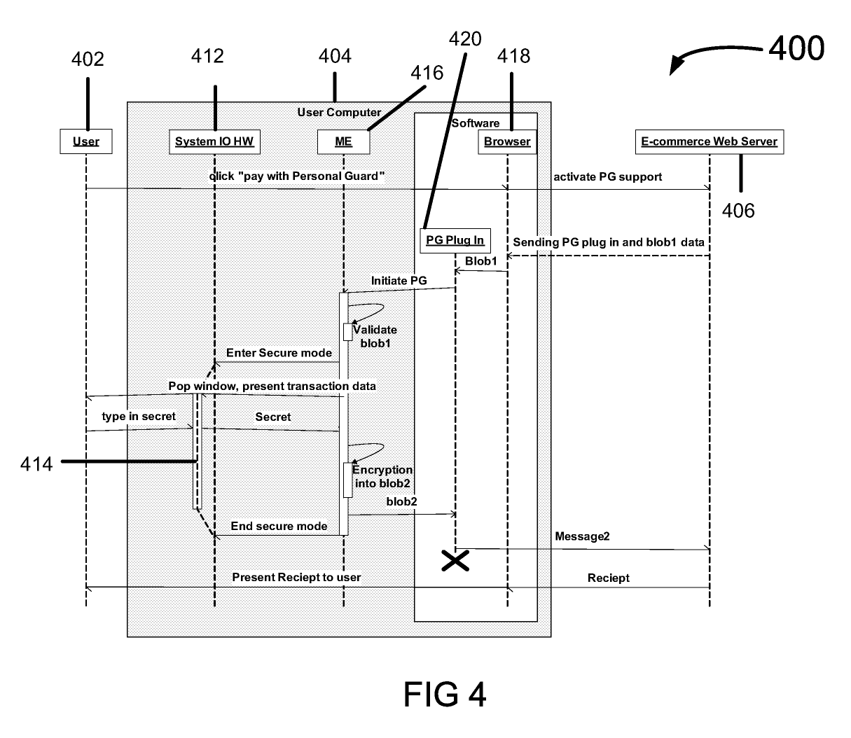

FIG. 4 illustrates a sequence diagram 400 according to some embodiments. Sequence diagram 400 includes a user 402, a computer 404 of the user 402, and a server (for example, an e-commerce web server) 406. Computer 404 includes system input/output hardware (system I/O HW) 412, an input device (for example, a keyboard and/or a mouse) 414, a management engine (and/or manageability engine and/or ME) 416, a browser 418, and a plug in 420. The system I/O HW 412, the input device 414, and the ME 416 are all implemented, for example, in hardware and/or firmware and the browser 418 and the plug in 420 are all implemented, for example, in software. User 402 is a person who is using computer 404 to browse a remote site for which secured input is desired. The user 402 wishes to secure the input using personal guard technology in order to send sensitive information (for example, as part of a transaction) to the remote server 406. System I/O HW 412 is core I/O control implementation within the computer 404 being used by user 402. It is implemented, for example, in the chipset of the computer 404, and includes modules that support secured input and secured output. The input device 414 is an external hardware device through which the user 402 enters sensitive data (for example, by typing in the sensitive data on a keyboard). The ME 416 is also included, for example, in the chipset of the computer 404 of the user 402 and controls the secured I/O flows of the system I/O HW and implements (for example, in firmware) the main personal guard flow. The browser 418 is the software that the user 402 normally executes on the computer 404 to browse web sites on the internet. It is noted that personal guard technology according to some embodiments may be used to harden the secured login, for example, of other internet technologies, so a web browser is just an example and is not required in some embodiments. Plug in 420 is a browser plug in used to convey data between the ME 416 (and/or personal guard firmware application) and the remote server 406. The remote server 406 (for example, an e-commerce web server) is a server with which the user 402 is executing some transactions. The server 406 is aware of the personal guard technology being used by the ME 416 and is therefore able to take advantage of secured transactions.

In some embodiments the user 402 clicks a selection such as “pay with Personal Guard” and the browser software 418 then activates Personal Guard support with the server 406. Server 406 then sends a Personal Guard plug in and data (for example, “blob 1”) to the Personal Guard plug in 420 via the browser 418. Plug in 420 then sends an “initiate Personal Guard” signal to the ME 416, which then validates the data (“blob 1”), and causes the user computer 404 to enter a secure mode, causing a pop up window to be displayed to the user 402 in which the user can securely enter sensitive and/or secret data. User 402 enters this data via input device 414 secretly and securely, and the ME 416 encrypts the data (for example, into “blob2”). In some embodiments, instead of typing in secret data via the input device 414, the user can choose data from a personal vault. For example, instead of typing in the secret data, in some embodiments the user 402 chooses data to fill in a field from existing data elements in the personal vault. In any case, the secret and encrypted data (either input by the user 402 specifically for that transaction or obtained from the personal vault) via the browser 418 and/or plug in 420 software to the server 406 (for example, as “message2”). The server 406 sends a receipt back to the computer 404, which is presented to the user 402. In this manner any sensitive and/or secret data input by the user 402 to the server 406 via computer 404 is securely transmitted, and software based keyloggers and/or any other types of malware are not able to hijack any of the input data.

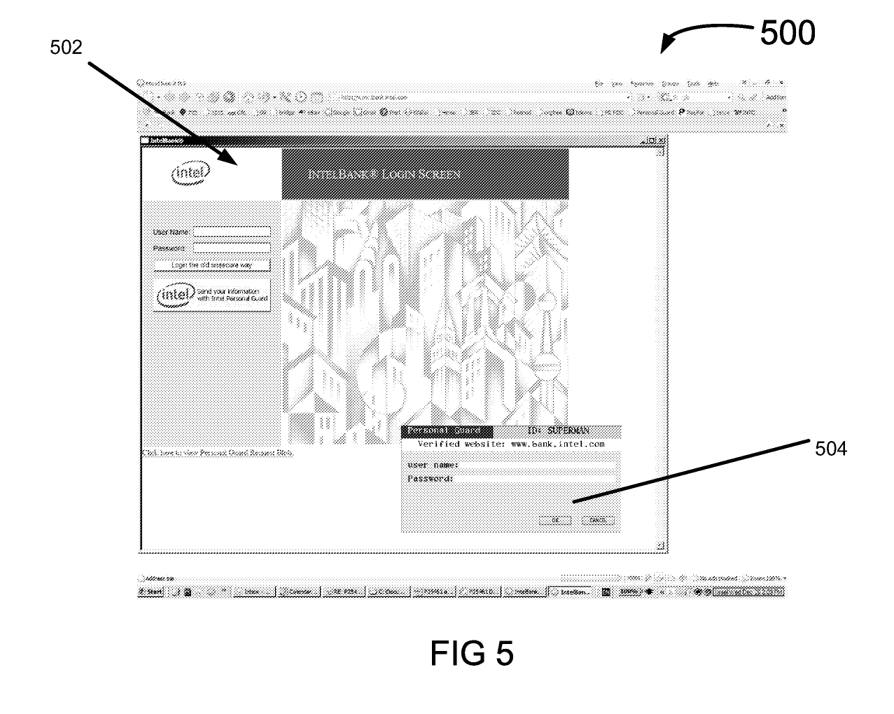

FIG. 5 illustrates a graphic representation 500 according to some embodiments. Graphic representation 500 includes a web site 502 of a vendor (for example, such as a bank or a web site shopping site, etc.) A special Personal Guard login may be used in addition to or instead of the typical web site login. A personal guard window 504 is output on the screen over or beside the web site display, for example, by an ME as secured graphics output through which a user communicates with the ME to convey sensitive information (such as credit card numbers, login credentials, a password to login to a web site, phone number, full name of user, address, social security numbers, etc.)

A personal guard plug in triggers the ME to show the personal guard window 504. Window 504 cannot be captured by software running on the CPU, for example. When data is encrypted by the ME, it is sent to the server of the web site (for example, Bank of America as shown in FIG. 5). The server of the web site is the only one who can decrypt the data and obtain the ID and/or passcode data, for example. The window 504 includes, for example, a special ID that ensures a user that the ME drew that window (for example, “ID: superman”), an animation (for example, “A” at top left of window 504) that runs when user input goes into the ME, an explicit URL of the remote server to help mitigate address-bar spoofing, which is the number one phishing technique of hackers (for example, in FIG. 5 “www.bankofamerica.com”), user credentials such as ID, passcode, etc. stored in secured storage of the ME so that a user does not need to type the data every time (after the initial ME login). The secured input allows the user to enter and manipulate the data, and user data may be clearly shown in window 504 or fully or partially blocked by using, for example, “********”, but in any case whether the data is shown or not shown in window 504 it cannot be read by any software application running on the user's computer or by a hacker trying to use keylogger software and/or other malware.

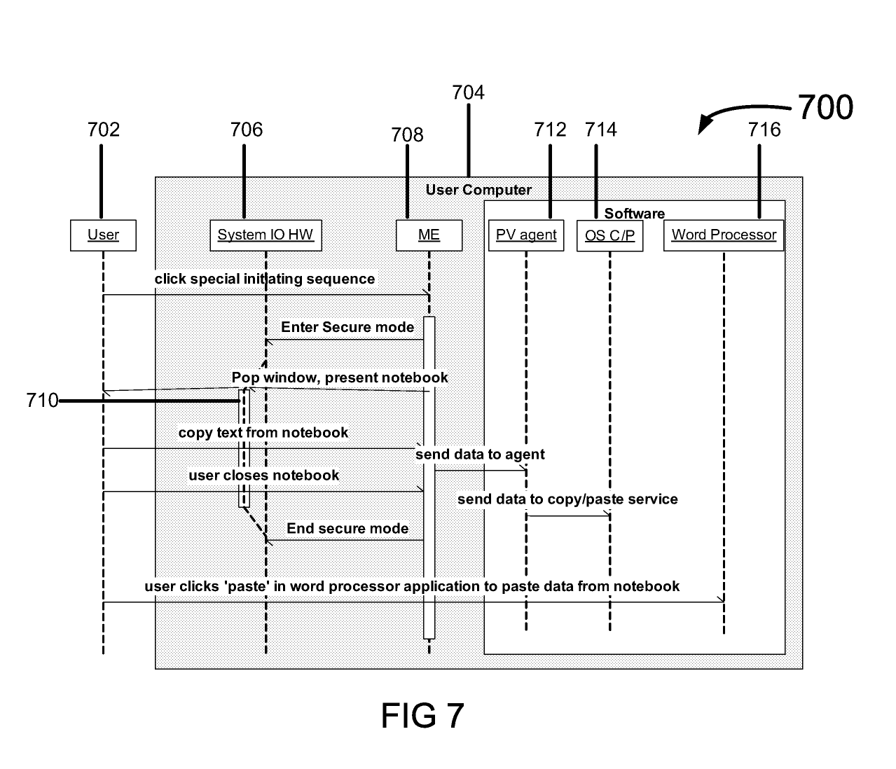

FIG. 6 illustrates a sequence diagram 600 according to some embodiments. Sequence diagram 600 illustrates a user 602 and a user computer 604 used by the user 602. In some embodiments sequence diagram 600 illustrates flow of a personal vault operation according to some embodiments. In FIG. 6, user computer 604 includes system I/O HW 606, a Management Engine (and/or Manageability Engine and/or ME) 608, and an input device 610 (for example, a keyboard and/or a mouse and/or any other type of input device).

As illustrated in the sequence diagram 600 of FIG. 6, a user 602 clicks a special initiating sequence to enter a secure personal vault mode, and the special initiating sequence request is received by the ME 608. ME 608 then causes the System I/O HW 606 and/or the entire user computer 604 to enter into a secure mode. This causes a window to pop up for the user to view in which a special personal vault notebook is displayed to the user 602. The user 602 is then able to input instructions on the input device 610 to read and/or write to the personal vault notebook, which is stored in a secure area controlled by the ME 608. Once the user 602 is finished reading and/or writing to the personal vault notebook, the user sends an instruction via the input device 610 to the ME 608 to close the personal vault notebook. The ME 608 then ends the secure mode operation.

The personal vault operation described herein is a use that builds on top of the same infrastructure used for personal guard operations (for example, implementing ME based secured input, output, and storage). The user is allowed to have a “secured notebook” to store personal sensitive information in such a way that keyloggers and/or malware is not able to steal it. As described herein, sensitive information that a user may want to store and maintain in a secure storage area includes, for example, credit card information, login credentials and/or passwords to sensitive sites, debit card PIN codes, social security numbers, phone numbers, addresses, full name information, etc. Such data might be subject to theft by keyloggers and/or malware that is looking for personal and/or sensitive information. This information might be subject to attack while the user is typing it into the file (for example, by a keylogger) or even by stealing a file that contains the sensitive information. In addition to stealing the information, malware may attack the user's computer and erase the file from a hard drive of the computer or encrypt it (as many ransomware programs are doing). In any of these cases a substantial loss may be suffered by the user.

In order to minimize this risk a personal vault use case according to some embodiments is implemented in a manner that is similar to the personal guard operations described above. In some embodiments, the user is able to pop up a secured notebook that is controlled by the ME. In some embodiments the notebook is a window that is fully controlled by the ME and it's content therefore cannot be hijacked by any software that runs on the host processor of the user's computer in a manner similar to the way that personal guard is implemented as described above. The user is able to use a special secured input (that is, a direct connection between the ME and an input device or devices such as a keyboard and/or a mouse and/or any other type of input device) so that any input information such as, for example, text typed on a keyboard cannot be hijacked by the running software such as a keylogger and/or malware.

In some embodiments, the ME monitors a special input sequence such as a special key sequence input on a keyboard in order to launch the personal vault notebook. Since all inputs (such as keyboard strokes) are filtered by the ME prior to the processor software stack, the software is not able to spoof or eliminate the personal vault flow.

In some embodiments, the flow implemented by the ME to pop up the personal vault notebook window can be configured, for example, via a special ME Basic Input/Output System (ME BIOS) extension window. In some embodiments, an ME BIOS extension module used for many other ME related configurations may also be extended to be used to configure the flow to pop up the personal vault notebook window. In some embodiments, a copy/paste may also be implemented between the secured personal vault notebook and the regular software running on the computer (for example, via a software agent.

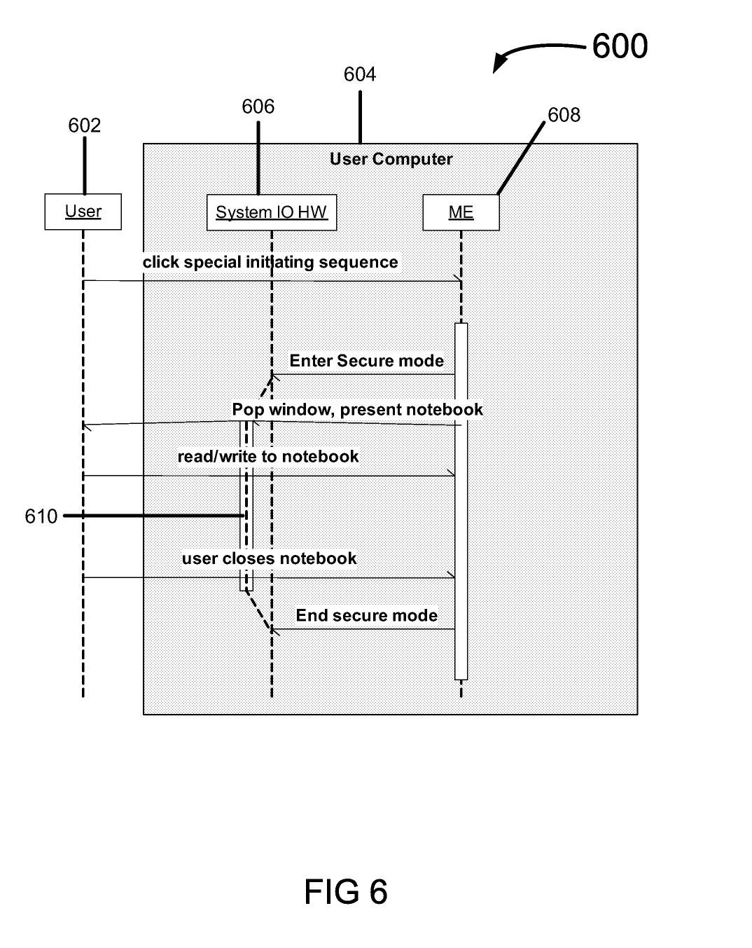

FIG. 7 illustrates a sequence diagram 700 according to some embodiments. Sequence diagram 700 illustrates a user 702 and a user computer 704 used by the user 702. In some embodiments sequence diagram 700 illustrates flow of a personal vault operation and/or a copy/paste operation between a personal vault and software running on a computer according to some embodiments. In FIG. 7, user computer 704 includes system I/O HW 706, a Management Engine (and/or Manageability Engine and/or ME) 708, and an input device 710 (for example, a keyboard and/or a mouse and/or any other type of input device). In some embodiments, user computer 704 further includes a personal vault agent (PV agent) 712, an Operating System copy/paste board (OS C/P) 714, and an application 716 (for example, a word processor application), each of which may be implemented in some embodiments in software.

As illustrated in the sequence diagram 700 of FIG. 7, a user 702 clicks a special initiating sequence to enter a secure personal vault mode, and the special initiating sequence request is received by the ME 708. ME 708 then causes the System I/O HW 706 and/or the entire user computer 704 to enter into a secure mode. This causes a window to pop up for the user to view in which a special personal vault notebook is displayed to the user 702. The user 702 is then able to input instructions on the input device 710 to copy text from the personal vault notebook which is in a secure area controlled by the ME 708. The ME 708 sends data to the PV agent 712, and the PV agent 712 sends the data to the OS C/P board 714 as a copy/paste service request. Once the user 702 is finished requesting the text to be copied the user sends an instruction via the input device 710 to the ME 708 to close the personal vault notebook. The ME 708 then ends the secure mode operation. The user 702 is then able to click ‘paste’ in an application 716 such as a word processor application to effectively paste the copied data from the personal vault notebook into the application 716.

In some embodiments a personal vault operation is implemented that enables copy/paste operations between a personal vault (also referred to herein as a “personal vault notebook”) and the Operating System (OS) that runs on the host processor of the system, for example. For example, in some embodiments, when a user wishes to implement a web transaction the user is able to copy and paste sensitive information that the user has previously stored in a personal vault notebook using personal vault technology. For example, in some embodiments a user may wish to use a credit card number stored in the personal vault to pay at an e-commerce web site in a situation where that web site does not currently support personal guard technology. Similarly, in some embodiments a user may want to paste a social security number of the user that has previously been stored in the secured personal vault notebook into an email.

In some embodiments, for example, a software agent running on the host processor of the user's computer (for example, that is a regular OS service) may also be used to interact with an ME personal vault. In some embodiments a copy/paste operation is made from a secured personal vault notebook to an OS (for example, in some embodiments as illustrated in FIG. 7 and described in reference to FIG. 7). In some embodiments, a copy/paste operation may be made from an OS to a secured personal vault notebook.

In some embodiments a personal vault agent 712 that runs as an OS service is used to receive data from the ME 708 and send it to the OS copy/paste board 714. This may be implemented using an interface mechanism that is already in place for other functions. The user can later use this data that has been sent to OS C/P 714 normally.

It is also pointed out that according to some embodiments the same flow as that illustrated in FIG. 7 and described in reference to FIG. 7 may be executed in reverse, for example, to make a copy/paste from an OS to a secured personal vault network. That is, the PV agent 712 reads information from the OS C/P 714. When the user 702 wants to paste some data into the secured personal vault notebook the ME 708 sends a query to the PV agent 712 which will obtain the data from the OS C/P 714 and send it back to the ME 708.

In some embodiments the ME 708 monitors a special input sequence input by the user 702 on the input device 710 (for example, a special key sequence entered on a keyboard). Once the special input sequence is received via the input device 710 the ME 708 launches the personal vault notebook. Since all inputs such as keyboard strokes are filtered by the ME 708 prior to the software stack of the processor of the user computer 704, the software cannot spoof or eliminate the flow of FIG. 7.

In some embodiments, a personal vault is used to store in the vault user credentials that are used as part of a personal guard implementation such as a personal guard transaction at a later time (for example, passwords, credit card numbers, etc.) The user can use these data items in a personal guard transaction at any time in a manner such that the data (for example, the credit card number) doe not need to be typed in every time a new transaction is desired. The user only needs to provide consent to personal guard technology in an ongoing transaction to use the data that is already stored in the personal vault. The user uses a secure I/O mechanism to give his/her consent and/or to pick the proper piece of data to fill in the field (for example, by picking one of three stored credit card numbers for the ongoing transaction).

Although some embodiments have been described herein as being implemented in a particular manner, according to some embodiments these particular implementations may not be required. For example, although some embodiments have been described as using an ME, other embodiments do not require use of an ME.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. An apparatus comprising:
a secure storage; and
a controller to encrypt data input to an input device before it is received by any software and to control the secure storage in a manner that information stored in the secure storage is not accessible to any software.

2. The apparatus of claim 1, the controller to provide a secure path between the input device and the controller.

3. The apparatus of claim 1, wherein the controller is located in a chip set of a computer.

4. The apparatus of claim 1, wherein the controller is a management engine.

5. The apparatus of claim 1, the controller to provide a secure path between the input device and the controller and the controller to encrypt data on the secure path between the input device and the controller.

6. The apparatus of claim 1, wherein information input via the input device is provided by the controller to the secure storage in a manner such that it is not accessible to any software.

7. The apparatus of claim 1, wherein information stored in the secure storage is provided by the controller to a user in a manner such that it is not accessible to any software.

8. The apparatus of claim 1, the controller to allow data to be provided from the secure storage to software in response to a request of a user.

9. The apparatus of claim 1, the controller to store data from software to the secure storage in response to a request of a user.

10. The apparatus of claim 1, wherein the information stored in the secure storage is personal information previously input by a user.

11. The apparatus of claim 1, wherein the controller is to securely receive personal information input by a user and store the personal information in the secure storage.

12. A method comprising:
encrypting data input to an input device before it is received by any software; and
storing securely information so that the information is not accessible to any software.

13. The method of claim 12, further comprising providing a secure path between the input device and a controller.

14. The method of claim 13, further comprising encrypting data between the input device and the controller.

15. The method of claim 12, further comprising providing information input via the input device to be securely stored in a manner such that it is not accessible to any software between when it is input and when it is securely stored.

16. The method of claim 12, further comprising providing the securely stored information to a user in a manner such that it is not accessible to any software.

17. The method of claim 12, further comprising providing the securely stored information to software in response to a request of a user.

18. The method of claim 12, further comprising storing securely data from software in response to a request of a user.

19. The method of claim 12, wherein the stored information is personal information previously input by a user.

20. The method of claim 12, further comprising receiving securely personal information input by a user and storing the personal information.

21. An article comprising:
a computer readable medium having instructions thereon which when executed cause a computer to:
encrypt data input to an input device before it is received by any software; and
store securely information so that the information is not accessible to any software.

22. The article of claim 21, the computer readable medium further having instructions thereon which when executed cause a computer to provide a secure path between an input device and a controller.

23. The article of claim 21, the computer readable medium further having instructions thereon which when executed cause a computer to encrypt data between the input device and the controller.

24. The article of claim 21, the computer readable medium further having instructions thereon which when executed cause a computer to provide information input via the input device to be securely stored in a manner such that it is not accessible to any software between when it is input and when it is securely stored.

25. The article of claim 21, the computer readable medium further having instructions thereon which when executed cause a computer to provide the securely stored information to a user in a manner such that it is not accessible to any software.

26. The article of claim 21, the computer readable medium further having instructions thereon which when executed cause a computer to provide the securely stored information to software in response to a request of a user.

27. The article of claim 21, the computer readable medium further having instructions thereon which when executed cause a computer to store securely data from software in response to a request of a user.

28. The method of claim 21, wherein the stored information is personal information previously input by a user.

29. The method of claim 21, the computer readable medium further having instructions thereon which when executed cause a computer to:
receive securely personal information input by a user; and
store the personal information.
